(19) United States
(12) Patent Application Publication
(10) Pub. No.: US 2020/0190854 A1
(43) Pub. Date: Jun. 18, 2020

(54) SECURITY SCREENING OF CHECKED LUGGAGE -- METHOD AND EQUIPMENT

(71) Applicant: David Tropp, Brooklyn, NY (US)

(72) Inventor: David Tropp, Brooklyn, NY (US)

(21) Appl. No.: 16/383,953

(22) Filed: Apr. 15, 2019

Related U.S. Application Data
(60) Provisional application No. 62/779,388, filed on Dec. 13, 2018.

(51) Int. Cl. E05B 35/10; E05B 37/00; E05B 65/52; E05B 47/00; E05B 19/00

(52) U.S. Cl. CPC E05B 35/105; E05B 37/0034; E05B 19/0047; E05B 47/0045; E05B 19/0058; E05B 65/52

(57) ABSTRACT

Method of securing and screening luggage with locks that the TSA and similar entity can open to screen travelers' luggage and dual-function locks used in the method, wherein the method comprises using first locks that the screening entity can open with a first master key and have the same traveler-operated portions, second locks that open with a second master key that is different from the first master key and have traveler-operated portions that differ from one second lock to another, and third locks that open with a third master key that differs from the first and second master keys and at least a portion of each third lock is permanently mounted to luggage of a selected brand only, wherein all first, second, and third locks have the same indicia identifying them as locks that the screening entity can open without breaking them or luggage.

### REFERENCE TO RELATED APPLICATIONS

This application claims benefit of U.S. Provisional Application No. 62/779,388 filed Dec. 13, 2018, the contents of which are hereby incorporated by reference.

### FIELD

This patent specification relates to locks and keys used on air travelers' luggage that is checked at airports and is subject to screening by the Transportation Security Administration (TSA) or similar government-authorized entities in this and other countries, and to methods of improving security and efficiency in such luggage screening.

### BACKGROUND

After the events of Sep. 11, 2001 that included the destruction of the World Trade Center, the TSA commenced screening checked luggage. Initially, the TSA recommended leaving checked luggage unlocked. When travelers did not do so, the TSA cut the locks to gain access for screening and later tried using a bundle of existing keys that might open some more common locks. Still later, two much more efficient systems were introduced. Both are still in use and more recently have been adopted by additional government-authorized luggage screening entities in this and other countries. Both systems rely on master keys and dual-function locks. The screening entity opens luggage with master keys that fit a master lock mechanism in each TSA-accepted dual-function lock while a user-operated lock mechanism in the same lock remains locked.

In the first system, the same master key opens the master lock mechanism of all locks identified to a logo showing that the locks are TSA-accepted. This includes locks that differ from each other in the type of their user-operated lock mechanisms, e.g., 3-dial combination lock mechanisms, 4-dial mechanisms, keyed mechanisms, etc. See U.S. Pat. Nos. 7,021,537, 7,036,728, 8,145,576, and 9,879,447, all incorporated by reference as though fully set out in this patent specification. The second system uses a different logo to identify TSA-accepted dual-function locks, and uses several different master keys. As to any individual one of the several different master keys, the second system is a duplicate of the first system except for the different logo. With respect to the collection of several different master keys, the second system adds a step in the screening process because one of the several master keys opens only locks that carry a number identifying that master key, a second master key only opens other locks that carry a number identifying the second master key, etc. TSA personnel screening checked luggage carry these master keys and use them to open and screen checked luggage locked with locks with one of these two logos. Locks that do not carry one of these logos may be cut to screen luggage content.

This patent specification is directed to improving systems and method related to locking and screening checked luggage to make them still more efficient and enhance security.

### SUMMARY OF THE DISCLOSURE

This patent specification describes systems and methods designed to improve the manufacture, supply, and use of dual-function locks and master keys used for securing checked luggage of air travelers and government-authorized luggage screening agency such as the TSA and similar entities in this and other countries. Examples of the improvements are described below and illustrated in drawings and summarized in claims.

### BRIEF DESCRIPTION OF THE DRAWINGS

FIGS. 1a, 1b, and 2-4 illustrate several different kinds of TSA-accepted dual-function locks that have different types of user-operated lock mechanisms.

FIGS. 5-8 illustrate schematically and in principle several master keys that are believed to be in current use by the TSA and similar entities.

FIGS. 9-15 illustrate high-security master key according to some embodiments.

FIG. 16 illustrates a system of combinations of dual-function locks and master keys according to some embodiments.

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all these details. Moreover, for the purpose of clarity, certain technical material that is known in the related art has not been described in detail in order to avoid unnecessarily obscuring the new subject matter described herein. Individual features of one or several of the specific embodiments described herein can be used in combination with features of other described embodiments or with other features. Further, like reference numbers and designations in the various drawings indicate like elements.

A dual-function lock that is TSA-accepted and is used in the method and system described in this patent specification has two locking mechanisms. Each opens and locks the lock independently of the other. One is a master lock mechanism and the other is a user-operated lock mechanism. There are different types of user-operated lock mechanisms in TSA-accepted locks. One type is a 3-dial combination locks, another is a 4-dial combination locks, yet another is a keyed lock mechanism, and there are additional types that are currently available or are expected to be available. The TSA-accepted luggage locks can be padlocks, built-in locks that are permanently affixed to luggage, zipper locks, and other locks. Such locks are available from sources including https://www.safeskieslocks.com/catalog/, many airport stores, and luggage stores in this country.

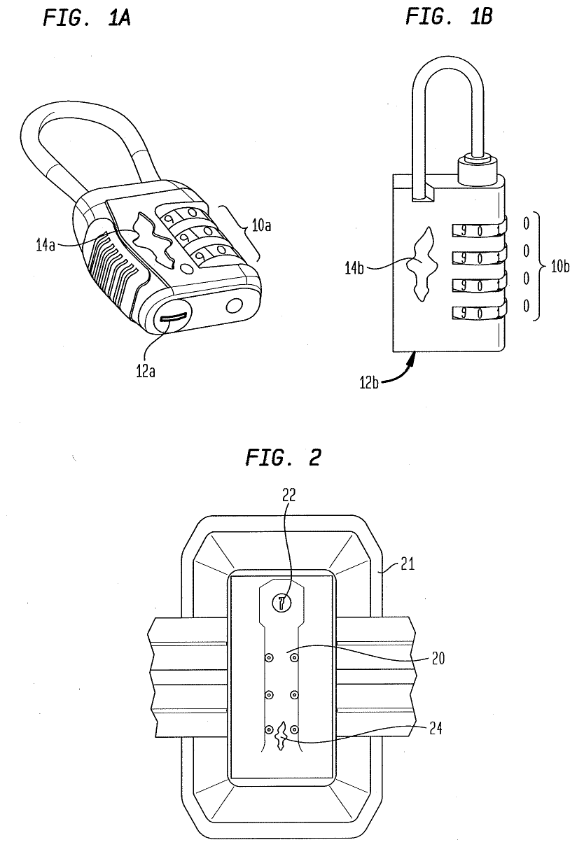

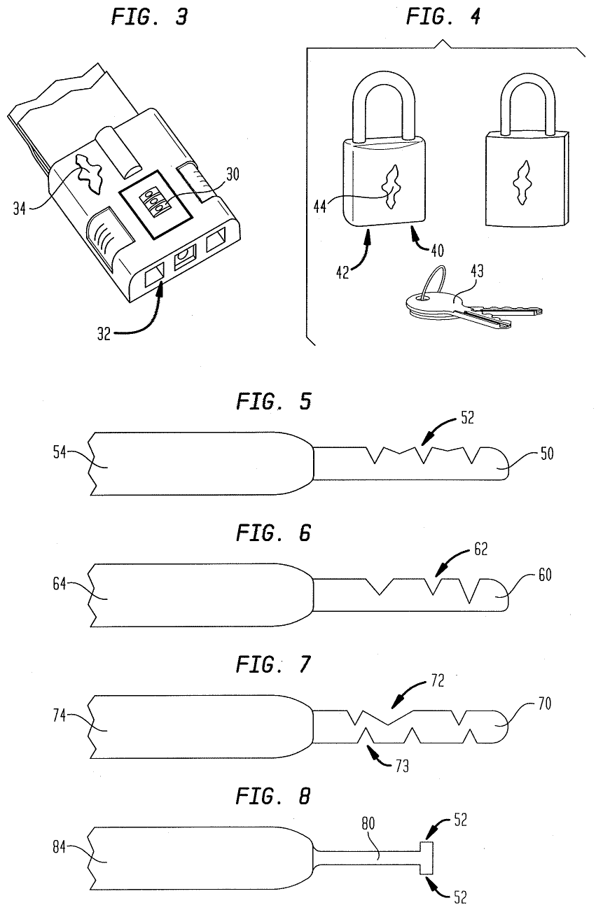

FIGS. 1a, 1b, and 2-4 show several types of TSA-accepted dual-function locks. FIG. 1a shows a TSA-accepted cable lock having a user-operated lock mechanism 10a that is a 3-dial combination lock, a master key lock mechanism 12a with a slot for a master key, and a readily visible Torch logo 14a informing that the lock is a TSA-accepted lock that the TSA and similar authorized entities can open the lock with a master key for luggage screening. FIG. 1b shows a TSA-accepted padlock having another type user-operated lock mechanism—designated 10b—that is a 4-dial combination lock mechanism, a master key lock mechanism 12b with a slot for a master key, and a Torch logo 14b informing that the lock is a TSA-accepted lock. FIG. 2 shows a part of luggage such as a suitcase 21 with a TSA-accepted lock permanently attached thereto, which lock has a 3-dial combination lock as a user-operated lock mechanism and additionally has a master lock mechanism 22 with a slot for a master key and a Torch logo 24. FIG. 3 shows a TSA-accepted luggage strap lock that has a user-operated lock mechanism 30 that also is 3-dial combination lock mechanism and a master lock mechanism 32 with a slot for a master key and a Torch logo 34. FIG. 4 shows a TSA-accepted lock with yet another type of user-operated lock mechanism—a keyed lock mechanism 40 that opens with user keys 43 controlled by a user—and additionally has a master lock mechanism 42 with a slot for a master key and a Torch logo 44. While only a padlock with a keyed user-operated lock mechanism is shown in FIG. 4, a keyed lock mechanism can be used in permanently mounted locks of the kind shown in FIG. 2 instead of a 3-dial combination lock mechanism, or in zipper locks as in FIG. 3. Other TSA-approved dual-function locks can have other types of user-operated lock mechanisms such as a finger-print operated mechanism, an electronic lock mechanism controlled wirelessly with a device such a smartphone, etc. In this patent specification the term types is used in to designate user-operated lock mechanisms that form a part of a dual-function lock and differ from each in structure and operation—for example, a 3-dial combination lock is different from a 4-dial combination lock because the two locks have different numbers of dials and associated internal components and operate differently as one requires manipulating 3 dials and the other requires manipulating 4 dials. Similarly, a combination lock is a type that is structurally and operationally different from a keyed lock and each is different in structure and operation from an electronic lock.

Master keys can be in different forms. Master keys in current use by the TSA for screening luggage are believed to comprise a blade with a bitting having cuts into the blade forming projections extending outwardly from the blade and arranged in a linear row, and a bow or handle. FIG. 5 schematically illustrates such a current key that has a blade 50 with bitting 52 forming a row of projections that extend up from one side of the blade. FIG. 6 illustrates another example where the master key has a blade 60 and a handle 64 formed as a single piece of sheet metal, and similar bitting 62 forming projection extending in a row up from blade 60. FIG. 7 illustrates a key otherwise the same as FIG. 6 but having an additional bitting 73 with projections in a row extending down from the blade. FIG. 8 shows another example that is otherwise the same as FIGS. 6 and 7 but has projections in a row up and down from the distal end of blade 80. FIGS. 5-8 are not to scale and do not show the actual operating portions of master keys in current TSA use.

New approaches described in this patent specification can improve the current systems for securing travelers' checked luggage and screening by authorized screening entities. According to some embodiments, one example of a new approach is to supply the luggage screening entities with three master key and supply three groups of dual-function locks. A first master key is a high-security master key that is unlike the master keys believed to the used by the TSA currently. This first, high-security master key is configured to open each master lock mechanism of each lock of a first group of locks by engaging the master lock mechanism thereof with key portions that differ from a row of cuts forming projections from a key blade as in said master key believed to be in current use by the TSA. A second master key is different from the first, high-security master key and is configured to open each master lock mechanism of each lock in the second group of locks, where each of some of the locks in the second group has one type of a user-operated lock mechanism but each of some other locks in the second group has a different type of a user-operated lock mechanism. A third master key is different from the first and second master keys and is configured to open each master lock mechanism of each lock in a third group of locks.

The first group of dual-function locks can consist of locks each having a 3-dial combination lock mechanism serving as the user-operated lock mechanism, e.g., a user operated lock mechanism as the one designated 10a in FIG. 1, 20 in FIG. 2, and 30 in FIG. 3, according to some embodiments. The locks in the first group can be the same overall kind in some embodiments, for example they can all be locks that are permanently attached to luggage, as in FIG. 2, or they can all be cable locks as in FIG. 1a.

Some of the locks in the second group can have the type of a user-operated lock mechanism, such as the 3-dial combination lock mechanism shown in the locks of FIGS. 1a, 2, and 3, while other locks that also are in the second group can have another type of a user-operated lock mechanism, such as the 4-dial combination lock mechanism shown in FIG. 1b or the keyed lock mechanism shown in FIG. 4.

The locks of the third group can all be locks that are permanently mounted in or on luggage, such as the lock of FIG. 2, or some of the locks of the third group can be different, e.g., they can be padlocks as in FIGS. 1b and 4, or zipper locks as in FIG. 3.

Each lock of the first and second group can have a readily visible indicia identifying the master key that opens the locks of the respective group. The indicia can be an alphanumeric sign, or another type of indicia such as a color or a 2-dimensional or 3-dimensional shape that identifies the master key that opens the lock. The locks of the third group also can have a designation of the appropriate master key, or they can be free of such a designation. The locks of the third group can be dedicated to only luggage of a selected brand. For example, the third master key and the third group of locks can be limited to use on luggage of a specific brand so that screening personnel will know by the brand of luggage that the third master key will open locks on that brand luggage. In addition, each dual-function lock in at least the first and second group has the same, readily visible indicia identifying the lock as a lock that screening entities can open with master keys. For example, the indicia can identify the locks as TSA-accepted locks. In some embodiments, the locks of the third group can have the indicia identifying them as TSA-accepted locks but in other embodiments they need not. Still in addition, at least the locks of the first and second group have indicia identifying the master key that opens the locks of the respective group. The locks of the third group may but need not have indicia identifying the third master key as the luggage brand with those locks may be a sufficient indication to the screening authority about which master key to use.

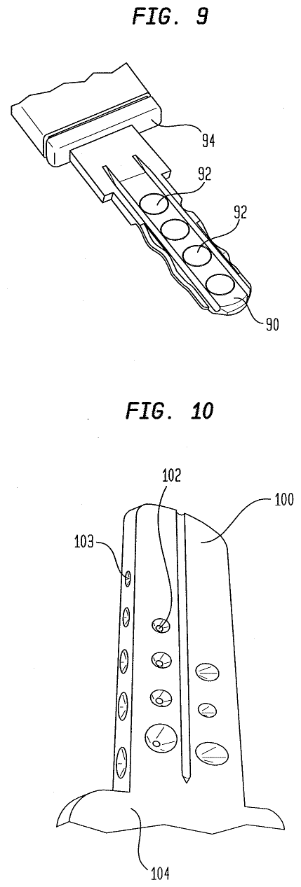

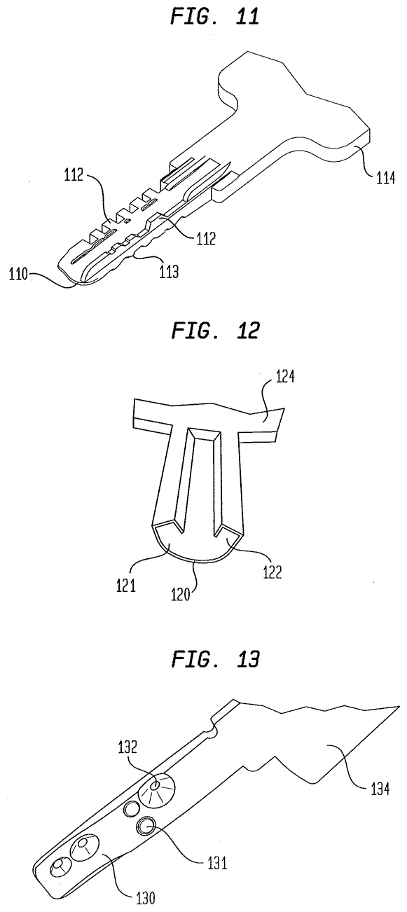

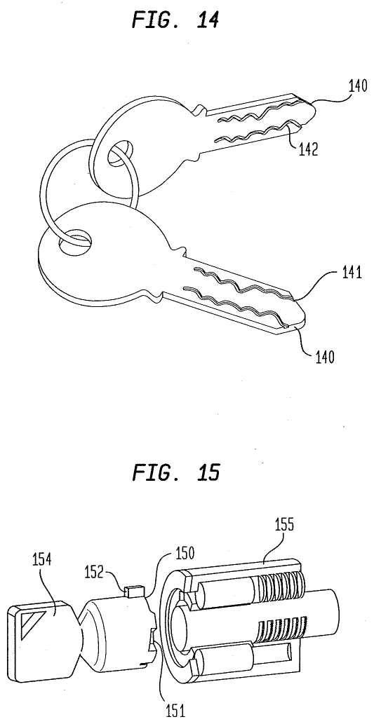

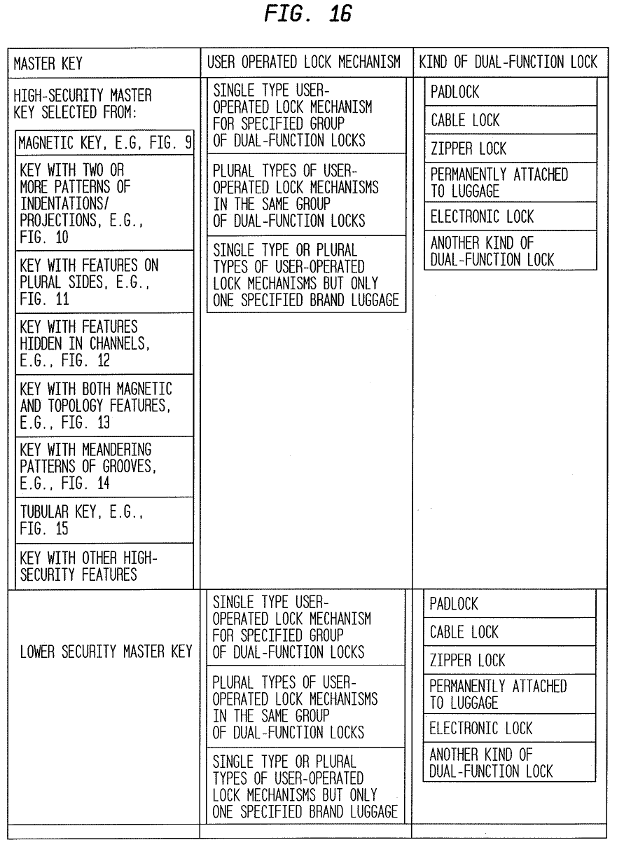

The first, high-security master key can be a key with a blade provided with a plurality of magnetic elements arranged in a selected pattern along the blade, as in FIG. 9, where a key with a blade 90 has a pattern of 4 magnetic elements 92 in a pattern along the blade and has a bow or handle 94, according to some embodiments. According to some embodiments, the high-security master key can be: as in FIG. 10, with indentations 102 in one pattern on one side of a blade 100 and indentations 103 in another pattern on another, perpendicular side of the blade (and possible indentations on one or both of the remaining sides of the blade) and a bow or handle 104; or as in FIG. 11, with a pattern 112 of indentations and/or projections on one or both sides of one surface of a blade 110 and another pattern 113 on an opposite side of the blade, and a bow or handle 114; or as in FIG. 12, with a blade 120 having two channels 121 and 122 each concealing a respective pattern of projections and/or indentations along the length of the channel; or as in FIG. 13, with a pattern of one or more magnetic elements 131 and one or more indentations and/or projections 132 along a blade 130 and a bow or handle 134; or as in FIG. 14, with channels or grooves such as 141 and 142 meandering in selected patterns along one or more than one surface on a blade 140, and a bow or handle 144; or as in FIG. 15, which illustrates a tubular high-security master key having a bow or handle 154 and an open distal end 150 with a circumference in which more than two indentations and/or projections are formed to engage tumblers in a master lock mechanism such as shown schematically at 155.

According to some embodiment, security and efficiency are improved by a system of dual-function locks each of which has a master lock portion and a user-operated lock portion and each of the lock portions locks and unlocks the lock independently of the other lock portion in the same lock, wherein each lock carries indicia identifying the lock as one that the TSA and similar government-authorized entities can open with a master key for screening. The locks include first dual-function locks each having said indicia and a user-operated lock portion that is the same in structure and operation as that of every other first dual-function lock, and each having a master lock portion that opens with a first master key only. For example, all first locks can have user-operated lock mechanisms that are 3-dial combination locks, as in FIGS. 1a, 2, and 3. The locks further include second dual-function locks, some having user-operated lock portions that differ from those of others of said second dual-function locks in structure and operation, and each second dual-function lock having a master lock portion that opens with a second master key only that differs from the first master key. For example, the second locks can include locks as in FIG. 2 as well as locks as in FIG. 4. The system further includes third dual-function locks each having a user-operated lock portion and a master lock portion that opens with a third master key only that differs from the first and second master keys, wherein each of at least some of the third locks is permanently mounted in or on luggage of a selected brand only.

In some embodiments, the first locks can have master lock mechanisms that open with a high-security master key, for example any of the keys shown in FIGS. 9-15. In some embodiments, the third locks can be limited to locks for luggage of a specified brand only.

In some embodiments, the improved system comprises dual-function locks carrying indicia identifying them as locks that the TSA can open with master keys for screening checked luggage, wherein each of said locks is a dual-function lock that has a master lock portion that opens the lock with a respective master key and a user-operated lock portion and each of the lock portions locks and unlocks the lock independently of the other lock portion in the same lock, in combination with first and second master keys. The system includes: first dual-function locks carrying indicia identifying a selected brand of luggage, and at least some of the first locks are permanently mounted in or on luggage; first master keys that open the master lock portions of all first locks only; second dual-function locks some of which have one type of a user-operated lock portion and some of which have another type of a user-operated lock portion, wherein the two types differ from each other in structure and operation; and second master keys that are different from the first master keys and open the master lock portions of all second locks only; wherein each of said master keys to opens air travelers' checked luggage for screening by unlocking the master lock portions thereof while the user-operated portions remain locked.

In some embodiments, the improved system comprises dual-function locks for air travelers' checked luggage subject to TSA screening, each lock having a master lock portion and a user-operated lock portion, said locks comprising: first dual-function locks in which said master lock mechanism opens with a first, high-security master key configured to open each first lock by engaging the master lock mechanism thereof with key portions that differ from a linear row of cuts forming projections from a key blade; second dual-function locks that open with a second master key that is different from the first, high-security master key and is configured to open the master lock mechanism of each of the second locks; and third dual-function locks that open with a third master key that is different from the first and second master keys and opens each master lock mechanism of each of the third locks. As one example, all the first locks have a user-operated lock portion that is a 3-dial combination lock mechanism.

As illustrated in the table of FIG. 16, the master keys in the improved system and method can use high-security keys, for example as in FIGS. 9-15, or other, lower-security keys, such as in FIGS. 5-8. The dual-function locks can be with a master lock mechanism that open with a high-security master key or with other master keys. The user-operation mechanisms of portions of a specified group of locks can be the same for all locks in the group, e.g., each lock in the group has a 3-dial combination lock mechanism serving as its user-operating lock mechanism. Or, a specified group of locks can include locks with user-operated lock mechanisms that differ in type—e.g., some are combination lock mechanisms as in FIG. 1a or FIG. 1b or FIG. 2 or FIG. 3 and others are keyed lock mechanisms, for example as in FIG. 4. The locks of one of the groups can be limited to locks for a specified brand of luggage, such as luggage of a widely used brand so that many of the items of luggage that need to be screened will be locked with locks in that group. The locks of a specified group can all be one kind, e.g., only padlocks as in FIGS. 1b and/or 4, or only locks with 3-dial combination locks as in FIGS. 1a, 2 and 4, or only locks permanently attached to luggage as in FIG. 2. In other embodiments, the locks of a specified group can include plural kinds of locks, e.g., both padlocks and locks permanently attached to luggage. Referring to FIG. 16, a master key selected from the high-security keys in the left column can be used with locks having any of the types of user-operated locks in the middle column and any of the kinds of dual-function locks in the right-hand column. Similarly, a lower-security master key can be used with locks having any of the types of user-operated lock mechanisms listed in the middle column, in any of the kinds of dual-function locks lister in the right column. This patent specification in some cases refers to groups of locks and in other cases to first locks, second lock, and third lock. The first locks form one group of locks, the second locks form another group of locks, etc. The specification refers to “types” regarding the user-operated lock mechanisms (e.g., 3-dial combination lock mechanisms, 4-dial combination lock mechanisms, keyed lock mechanisms) but to “kinds” of locks regarding dual-function locks such as padlocks, zipper lock, and locks permanently attached to luggage.

As apparent to persons skilled in the pertinent technology, master keys suitable for the purposes described in this specification can be manufactured by lock factories in this country or in other countries such as Germany and China, such as factories that have manufactured the master keys in current use by the TSA, given the information contained herein. Similarly, the dual-function locks described herein can be manufactured by factories in this country or in other countries such as Germany or China, given the specifications described herein. High-security lock mechanisms and high-security keys for them are currently available commercially for uses other than those described herein.

The improved system and methods are in some ways counterintuitive rather than a logical extension of the known current luggage screening by the TSA and similar entities. For example, locks for high-security master key contradicts known ideas that locks and master keys need to be inexpensive; a master key limited to locks on luggage of a specified brand contradicts known ideas that a master key should open any brand luggage; and a master key that only opens locks with a single type of a user-operated lock, for example a 3-dial combination lock, may contradict known ideas that at least some master keys should open plural types of locks. Additional unexpected benefits of the new system and method will be apparent to persons skilled in screening checked luggage and persons skilled in manufacturing locks and master keys and in supplying master keys and TSA-accepted dual-function locks.

Although the foregoing has been described in some detail for purposes of clarity, it will be apparent that certain changes and modifications may be made without departing from the principles thereof. There can be many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

1. A method of screening air travelers' checked luggage locked with locks, wherein some of the luggage is locked with locks of a first group of locks, some is locked with locks that are in a second group of locks, and some is locked with locks that are in a third group of locks, wherein each of said locks is a dual-function lock that has a master lock portion and a user-operated lock portion and each of the lock portions locks and unlocks the lock independently of the other lock portion in the same lock, said method comprising:
supplying a luggage screening entity with a first, high-security master key configured to open each master lock mechanism of each lock of the first group of locks by engaging the master lock mechanism thereof with key portions that differ from a linear row of cuts forming projections from a key blade;
supplying the luggage screening entity with a second master key that is different from the first, high-security master key and is configured to open each master lock mechanism of each lock in the second group of locks;
supplying the luggage screening entity with a third master key that is different from the first and second master keys and is configured to open each master lock mechanism of each lock in the third group of locks;
manufacturing and providing the first, second and third group of locks, wherein the user-operated portions of some of the locks in the second group have user-operated portions that differ structurally and operationally from those in other locks of the second group of locks and including in each lock indicia identifying the lock as accepted by the luggage screening entity and identifying each lock of the first and second group but not the third group by indicia identifying the master key that opens the lock; and
pursuant to government authorization and a memorandum of understanding between the luggage screening entity and an entity supplying the master keys, using the master keys to open for screening air travelers' checked luggage locked with said locks by unlocking the master lock portions thereof while the user-operated portions remain locked.

2. The method of claim 1, in which the step of providing the locks of the third group comprises providing dual-function locks each of which is permanently mounted in or on luggage of a selected brand only.

3. The method of claim 3, further including in each lock of the first and second group but not the third group readily visible indicia identifying the master key that opens the locks of the respective group.

4. The method of claim 1, further including in each lock readily visible indicia identifying the lock as a lock that can be opened with one of said master keys and including in the locks of the first and second group indicia identifying the master key that opens the locks of the respective group.

5. The method of claim 1, in which the step of supplying the first master key comprises supplying a key with a blade provided with a plurality of magnetic elements arranged in a selected pattern along the blade.

6. The method of claim 1, in which the step of supplying the first master key comprises supplying a key with a blade having at least two surfaces each of which has plural indentations and projections in respective patterns that differ from each other.

7. The method of claim 1, in which the step of supplying the first master key comprises supplying a tubular key having a distal open end with a circumference provided with plural depressions and/or projections arranged in a selected pattern.

8. A method of screening air travelers' checked luggage locked with locks, wherein some of the luggage is locked with locks of a first group of locks and some is locked with locks that are in a second group of locks, wherein each of said locks is a dual-function lock that has a master lock portion and a user-operated lock portion and each of the lock portions locks and unlocks the lock independently of the other lock portion in the same lock, said method comprising:
supplying a luggage screening entity with a first master key configured to unlock each the locks of the first group of locks by engaging the master lock mechanism thereof;
supplying the luggage screening entity with a second master key that is different from the first master key and is configured to open each master lock mechanism of each lock in the second group of locks;
manufacturing and providing the first and second group of locks, wherein the locks of the first group carry indicia identifying the first master key, the locks of the second group carry indicia identifying a selected brand of luggage, and at least some of the locks of the second group are permanently mounted in or on luggage; and
pursuant to government authorization and a memorandum of understanding between the luggage screening entity and an entity supplying the master keys, using the master keys to open for screening air travelers' checked luggage locked with said locks by unlocking the master lock portions thereof while the user-operated portions remain locked.

9. The method of claim 8, in which the manufacturing and providing step comprises providing the locks of the second group free of an identification of the second master keys.

10. A method of screening air travelers' checked luggage locked with locks, wherein some luggage is locked with locks of a first group of locks and some is locked with locks that are in a second group of locks, wherein each of said locks is a dual-function lock that has a master lock portion and a user-operated lock portion and each of the lock portions locks and unlocks the lock independently of the other lock portion in the same lock, said method comprising:
supplying a luggage screening entity with a first master key configured to open each master lock mechanism of each lock of the first group of locks;
supplying the luggage screening entity with a second master key that is different from the first master key and is configured to open each master lock mechanism of each lock in the second group of locks;
manufacturing and providing the first and the second group of locks, wherein the user-operated portions of the locks of the first group are 3-dial lock mechanisms only and wherein some of the locks in the second group have user-operated portions that differ structurally and operationally from those in other locks of the second group of locks; and
using the first a second master keys, pursuant to government authorization and a memorandum of understanding between the luggage screening entity and an entity supplying the master keys, to opens air travelers' checked luggage locked with said locks by unlocking the master lock portions thereof while the user-operated portions remain locked.

11. The method of claim 10, in which the step of supplying the first master key comprises manufacturing and supplying a high-security master key configured to open each master lock mechanism of each lock of the first group of locks by engaging the master lock mechanism thereof with key portions that differ from a linear row of cuts forming projections from a key blade.

12. The method of claim 11, in which the step of supplying the first master key comprises manufacturing and supplying a master key having a blade with a pattern of magnetic elements arranged in a selected pattern along said blade.

13. The method of claim 1, in which the step of supplying the first master key comprises supplying a tubular key having a distal open end with a circumference provided with plural depressions and/or projections arranged in a selected pattern.

14. Dual-function locks each of which has a master lock portion and a user-operated lock portion and each of the lock portions locks and unlocks the lock independently of the other lock portion in the same lock, wherein each lock carries indicia identifying the lock as one that the TSA can open with a master key for screening, comprising:
first dual-function locks, each having said indicia and a user-operated lock portion that is the same in structure and operation as that of every other first dual-function lock, and each having a master lock portion that opens with a first master key only;
second dual-function locks, some having user-operated lock portions that differ from those of others of said second dual-function locks in structure and operation, and each second dual-function lock having a master lock portion that opens with a second master key only that differs from the first master key; and
third dual-function locks, each having said indicia and a master lock portion that opens with a third master key only that differs from the first and second master keys, wherein each of at least some of the third locks is permanently mounted in or on luggage of a selected brand only.

15. The dual-function locks of claim 14, in which the user-operated lock portion of each first lock is a 3-dial combination lock mechanism.

16. The dual-function locks of claim 14, in which each first lock opens with a high-security master key configured to open the lock by engaging the master lock mechanism thereof with key portions that differ from a linear row of cuts forming projections from a key blade

17. The dual-function locks of claim 16, in which said high-security key is a tubular key having a distal open end with a circumference provided with plural depressions and/or projections arranged in a selected pattern.

18. Dual-function locks carrying indicia identifying them as locks that the TSA can open with master keys for screening checked luggage, wherein each of said locks is a dual-function lock that has a master lock portion that opens the lock with a respective master key and a user-operated lock portion and each of the lock portions locks and unlocks the lock independently of the other lock portion in the same lock, in combination with first and second master keys, comprising:
first dual-function locks carrying indicia identifying a selected brand of luggage, at least some of the first locks being permanently mounted in or on luggage;
first master keys that open the master lock portions of all first locks only;
second dual-function locks some of which have one type of a user-operated lock portion and some of which have another type of a user-operated lock portion, wherein the two types differ from each other in structure and operation;
second master keys that are different from the first master keys and open the master lock portions of all second locks only;
wherein each of said master keys to opens air travelers' checked luggage for screening by unlocking the master lock portions thereof while the user-operated portions remain locked.

19. Dual-function locks for air travelers' checked luggage subject to TSA screening, each lock having a master lock portion and a user-operated lock portion, said locks comprising:
first dual-function locks in which said master lock mechanism opens with a first, high-security master key configured to open each first lock by engaging the master lock mechanism thereof with key portions that differ from a linear row of cuts forming projections from a key blade;
second dual-function locks that open with a second master key that is different from the first, high-security master key and is configured to open the master lock mechanism of each of the second locks;
third dual-function locks that open with a third master key that is different from the first and second master keys and opens each master lock mechanism of each of the third locks.

20. The dual-function locks of claim 19, in which all the first locks have a user-operated lock portion that is a 3-dial combination lock mechanism.
